(19) United States
(12) Patent Application Publication
(10) Pub. No.: US 2025/0065607 A1
(43) Pub. Date: Feb. 27, 2025

(54) INTERLAYERS HAVING FUNCTIONAL PROPERTIES FOR LAMINATED ASSEMBLIES

(71) Applicant: DelStar Technologies, Inc., Alpharetta, GA (US)

(72) Inventors: David Collette, South Hadley, MA (US); Nandan Ukidwe, Suffield, CT (US)

(21) Appl. No.: 18/802,112

(22) Filed: Aug. 13, 2024

Related U.S. Application Data
(60) Provisional application No. 63/578,437, filed on Aug. 24, 2023.

(51) Int. Cl. B32B 17/10

(52) U.S. Cl. CPC B32B 17/1077; B32B 17/10036; B32B 17/10431; B32B 17/10678; B32B 2274/00; B32B 2307/414; B32B 2307/558; B32B 2307/7376; B32B 2419/00; B32B 2571/02; B32B 2605/00

(57) ABSTRACT

Interlayers for use with laminates and laminates are provided that may be used in a variety of different applications, such as windows for vehicles and buildings, impact resistance devices, such as bulletproof glass and others, decorative films for windows, walls or doors, window tinting, colored or mirrored glass, window films and the like. An interlayer comprises an adhesive film having a monolithic structure comprising a thermoplastic polyurethane (TPU). The film comprises one or more functional elements disposed within its monolithic structure and has a thickness of at least about 0.015 inches. The interlayer is a single TPU layer that includes both adhesive and functional properties, which allows the interlayer to be attached to one or more outer transparent layers in a laminate assembly that is particularly useful in, for example, applications requiring solar control functionality, such as windows that absorb or reflect heat, IR and/or UV light and the like.

### CROSS-REFERENCE TO RELATED APPLICATIONS

This application claims the benefit of U.S. Provisional Application Ser. No. 63/578,437, filed Aug. 24, 2023, the complete disclosure of which is incorporated herein by reference for all purposes.

### TECHNICAL FIELD

This description generally relates to interlayers for use in laminated assemblies having functional properties such as solar control functionality, and/or optical elements, such as UV absorbers, UV reflectors, IR absorbers, IR reflectors and the like.

### BACKGROUND

Laminated Glazing Units (LGUs) are laminated assemblies including one or more interlayer plies interposed between transparent rigid plies. The rigid plies can be glass or any other well-known substitute such as polycarbonates, acrylic resins, polyesters, and rigid transparent polyurethanes. The interlayer, which bonds adjacent rigid plies together to form a unified laminated assembly, may be a thermoplastic material such as polyvinyl formal, polyvinyl butyral, polyvinyl iso-butyral, silicone or ethylene vinyl acetate (EVA).

More recently, the performance demands on such laminates used in automotive or architectural markets have expanded well beyond simple optical clarity and impact resistance. LGUs have become a more significant component of commercial buildings and residential dwellings often as an integral part of the structure itself. In such cases, the interlayer is increasingly expected to provide solar control functionality to reduce loads on building HVAC system, improve cabin comfort and energy efficiency of the vehicle, etc. With the advances in photovoltaic technologies, building integrated photovoltaics (BIPV) are gaining popularity as well. In the latter case, LGUs are combined with photovoltaic cells positioned along the laminate edge, and incident solar radiation is wave-guided to the edges with the help of variety of luminophores including but not limited to inorganic semiconductor quantum dots.

Traditional interlayers for lamination between outer transparent layers, such as glass, in automotive or architectural markets have included plasticized polyvinyl butyral (PVB). Plasticized PVB is commonly produced through extrusion processes and offers good adhesion to glass, excellent optical clarity, good durability and high impact resistance.

The current technology to produce laminate structures with solar control capabilities requires the use of two layers of a thick (0.015″ to 0.050″) adhesive interlayer film, such as PVB, and one layer of a thin (0.002″) functional film with solar control properties. The thicker interlayer films provide the requisite adhesive properties for laminating with glass or similar materials, while the thinner functional film provides the solar control properties.

### SUMMARY

Interlayers for use with laminates and laminates are provided that may be used in a variety of different applications, such as windows for vehicles and buildings, impact resistance devices, such as bulletproof glass and others, decorative films for windows, walls or doors, window tinting, colored or mirrored glass, window films and the like.

In one aspect, an interlayer for a laminate comprises an adhesive film having a monolithic structure comprising thermoplastic polyurethane (TPU). The film comprises one or more functional elements within the monolithic structure and has a thickness of at least about 0.015 inches. The interlayer is a single TPU layer that includes both adhesive and functional properties, which allows the interlayer to be attached to one or more outer transparent layers in a laminate assembly that is particularly useful in, for example, applications requiring solar control functionality, such as windows that absorb or reflect heat, IR and/or UV light and the like.

In certain embodiments, the interlayer may be adhered to a single outer layer. In other embodiments, the interlayer may be adhered to first and second outer layers on opposite surfaces of the interlayer. The first and/or second outer layers may comprise any optically transparent material with sufficient rigidity for the given application. Suitable materials for outer layers include, but are not limited to, glass, artificial glass polycarbonates, acrylic resins, polyesters, polyethers, and polyurethanes. In an exemplary embodiment, the outer layers comprise glass, polycarbonate or acrylic.

In embodiments, the TPU interlayer has a thickness of about 0.015 inches to about 0.10 inches or about 0.015 inches to about 0.04 inches, or about 0.02 to about 0.025 inches.

The TPU layer may comprise any suitable thermoplastic polyurethane, such as polyesters, polyethers, polycaprolactone or the like. In an exemplary embodiment, the TPU layer comprises aliphatic TPU, preferably a polyether aliphatic TPU. The polyether aliphatic TPU may have a hardness in the range of about 60 Shore A to about 100 Shore A, or about 70 Shore A to about 85 Shore A.

In embodiments, the interlayer is substantially optically clear. Thus, the interlayer may have a haze of less than about 4%, or less than about 3%, or less than or equal to about 1.7%, or less than or equal to about 1%. The interlayer may have a visible light transmission percentage (VLT %) of greater than about 30%, or greater than about 50%, or greater than about 70%, or greater than about 80% or about 86% or greater. The interlayer may have an ultraviolet to visible spectrum transmission (UV-VIS) of about less than about 10% or less than about 5% or less than or equal to about 1%. The interlayer may have a yellowness index (E313) of less than about 6, or less than about 5, or less than about 4, or less than about 2.

In embodiments, the interlayer may substantially block or reflect certain wavelengths in the range of 100-400 nm. In one such embodiment, the interlayer may a light transmission at 380 nm of less than about 0.1 percent, or less than about 0.05 percent or less than or equal to about 0.04 percent. The interlayer may have a light transmission at 400 nm of less than about 50%, or less than about 10%, or less than about 2%, or less than about 1%, or less than about 0.02 percent.

In embodiments, the TPU layer comprises a first upper layer and a second lower layer. The first and second layers may be extruded separately or together as part of a single process. In either process, they form a single monolithic TPU interlayer that incorporates the internal solar control properties. In an exemplary embodiment, the first and second layers may each have a thickness of about 0.005 to about 0.025 inches, preferably about 0.005 to about 0.015 inches, or about 0.01 inches.

In embodiments, the adhesive film further comprises a third TPU layer disposed between the first and second TPU layers. In an exemplary embodiment, the third TPU layer preferably comprises a polycaprolactone-based TPU. The polycaprolactone-based TPU may have a hardness of about 40 Shore D to about 85 Shore D, or about 55 Shore D to about 70 Shore D.

In embodiments, the adhesive film comprises a functional film or coating adhered to the third TPU layer. The functional properties, such as solar control elements, are disposed on the functional film coating. The functional film coating and the third TPU layer may have a thickness suitable for incorporating solar control elements onto the film coating, preferably less than about 0.003 inches, or less than about 0.001 inches, or about 0.0008 inches.

The functional film may be coated onto the third TPU layer in any suitable manner, such as such drop casting, dip coating, optical deposition, vacuum deposition, electrospinning, electro spraying, layer-by-layer deposition, spin coating and the like. In an exemplary embodiment, the functional film is sputter coated onto the carrier film.

In embodiments, the first TPU layer is adhered to the third TPU layer and the first TPU layer is adhered to the functional film coating. In embodiments, the first and second TPU layers are extruded onto the third TPU layer and the functional film coating, either simultaneously or sequentially. In an exemplary embodiment, the second TPU layer is first extruded onto the functional film coating, and the first TPU layer is then extruded onto the third TPU layer to form a monolithic interlayer.

In embodiments, the functional properties comprise one or more of luminophores, solar control elements, ionomers, optical elements, such as UV absorbers, UV reflectors, IR absorbers, IR reflectors and any combination thereof. The luminophores may comprise phosphorescent organic molecules, quantum dots, organic dyes or combinations thereof. The optical elements may comprise materials and/or layers made from materials that allow the transmission of visible light and reflect or absorb UV and/or IR light.

In embodiments, the solar control elements comprise one or more of heat absorbers, heat reflectors, light filters, photovoltaic assemblies, electrochromic assemblies and any combination thereof.

In embodiments, the interlayer is non-linear. The TPU is selected such that it is bendable or formable to create bent or curved laminates with solar control properties.

In another aspect, a laminate is provided comprising one of the interlayer(s) described above.

In another aspect, a window is provided comprising the laminate described above.

In another aspect, a decorative film is provided comprising the laminate described above.

In another aspect, a laminate comprises a first optically transparent outer layer and a second layer adhered to the first layer. The second layer has a monolithic structure comprising thermoplastic polyurethane (TPU) and one or more functional elements within its monolithic structure. The second layer has a thickness of at least about 0.015 inches.

The functional elements may include, for example, luminophores, solar control elements, ionomers, optical elements, such as UV absorbers, UV reflectors, IR absorbers, IR reflectors and any combination thereof.

In embodiments, the laminate comprises a third optically transparent layer adhered to the adhesive film. The TPU layer is disposed between the first and third outer layers. The first and/or third transparent layers may comprise a material selected from the group consisting of glass, artificial glass, polycarbonates, acrylics, polyesters, polyethers, and polyurethanes. In an exemplary embodiment, the first and third layers comprise glass, polycarbonate or acrylic.

In one embodiment, the first and third layers comprise glass and the functional elements comprise solar control elements selected from a group consisting of heat absorbers, heat reflectors, light filters, photovoltaic assemblies, electrochromic assemblies and any combination thereof.

In another embodiment, the first and third layers comprise polycarbonate and the functional elements comprise solar control elements selected from a group consisting of heat absorbers, heat reflectors, light filters, photovoltaic assemblies, electrochromic assemblies and any combination thereof. In an exemplary embodiment, the laminate is impact resistant or bulletproof.

In another embodiment, the first and third layers comprise acrylic and the functional elements comprise solar control elements selected from a group consisting of heat absorbers, heat reflectors, light filters, photovoltaic assemblies, electrochromic assemblies and any combination thereof. In an exemplary embodiment, the laminate comprises a decorative layer or film that may be, for example, useful for application to windows, doors, walls or other interior or exterior portions of buildings, vehicles, or the like.

In another aspect, a solar control window is provided comprising one of the laminates described above, wherein the first and third outer layers comprise glass. In an exemplary embodiment, the window comprises a panoramic roof for an automobile.

In another aspect, an impact resistant window is provided that includes first and second rigid transparent outer layers and one of the laminate(s) described above. The first and second outer layers comprise polycarbonate.

In another aspect, a decorative layer or film is provided that includes one of the laminate(s) described above, wherein the first and second outer layers comprise acrylic.

In exemplary embodiments, functional glass and artificial glass laminates are provided that incorporate an electrochromic assembly and a photovoltaic assembly, with the photovoltaic assembly providing power to the electrochromic assembly. In some embodiments, additional layers can be added on the electrochromic assembly on the side opposite the photovoltaic assembly, to further insulate the interior of a building or car from any added heat generated where the laminate is used as a window, skylight, etc. The laminate can be incorporated in a self-contained window unit, without requiring wiring connections outside of the unit, improving the energy efficiency of a building or vehicle.

In another aspect, an interlayer for a laminate comprises a first thermoplastic polyurethane (TPU) layer, a second TPU layer and a third polymer layer disposed between the first and second polymer layers and comprising one or more functional elements.

In embodiments, the third polymer layer comprises TPU.

In embodiments, the interlayer further comprises a coating on the third polymer layer, wherein the one or more functional elements are disposed on the coating. The coating may be applied to the third polymer layer in any suitable manner. In one embodiment, the coating is sputter coated to the third TPU layer.

In embodiments, the coating and the third TPU layer have a thickness of less than about 0.003 inches.

In embodiments, the interlayer further comprises an optical material on the first TPU configured to reflect or absorb UV light. The interlayer may comprise a second optical material on the second TPU layer configured to reflect or absorb UV light.

In embodiments, the first, second and third layers form a monolithic structure having a thickness of at least about 0.015 inches, or about 0.015 to about 0.1 inches.

In embodiments, the interlayer is substantially optically clear. Thus, the interlayer may have a haze of less than about 4%, or less than about 3%, or less than or equal to about 1.7%, or less than or equal to about 1%. The interlayer may have a visible light transmission percentage (VLT %) of greater than about 30%, or greater than about 50%, or greater than about 70%, or greater than about 80% or about 86% or greater. The interlayer may have an ultraviolet to visible spectrum transmission (UV-VIS) of about less than about 10% or less than about 5% or less than or equal to about 1%. The interlayer may have a yellowness index (E313) of less than about 6, or less than about 5, or less than about 4, or less than about 2.

In embodiments, the interlayer may substantially block or reflect certain wavelengths in the range of 100-400 nm. In one such embodiment, the interlayer may a light transmission at 380 nm of less than about 0.1 percent, or less than about 0.05 percent or less than or equal to about 0.04 percent. The interlayer may have a light transmission at 400 nm of less than about 50%, or less than about 10%, or less than about 2%, or less than about 1%, or less than about 0.02 percent.

### BRIEF DESCRIPTION OF THE DRAWINGS

The accompanying drawings, which are incorporated in and constitute a part of this specification, illustrate several embodiments of the disclosure and, together with the description, serve to explain the principles of the disclosure.

FIG. 1 is a schematic cross-sectional view of a multilayer laminate according to an exemplary embodiment;

FIG. 2 is a schematic cross-sectional view of a multilayer laminate according to another exemplary embodiment;

FIG. 3 is a graph illustrating light transmission values at a range of wavelengths;

FIG. 4 illustrates the light transmission spectra at 380 nm for certain laminates described herein; and

FIG. 5 illustrates the light transmission spectra at 400 nm for certain laminates described herein.

### DETAILED DESCRIPTION

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Interlayers for use in laminates and laminates including the interlayers are provided that may be used in a variety of different applications, such as windows for vehicles and buildings, impact resistance devices, such as bulletproof glass and others, decorative films for windows, walls or doors, window tinting, colored or mirrored glass, window films and the like. The laminates may be particularly useful in, for example, applications requiring solar control functionality, such as windows that absorb or reflect heat, IR and/or UV light and the like. The laminates are preferably optically clear and may exhibit optoelectrical properties.

In certain embodiments, as represented in FIG. 1, a laminate 100 comprises first and second optically transparent optical layers 110, 120 and an adhesive interlayer 125 laminated between the first and second outer layers 110, 120. Interlayer 125 is a monolithic structure comprising a thermoplastic polyurethane (TPU) that has a sufficient thickness to adhere to outer layers 110, 120, preferably at least about 0.015 inches. Monolithic is defined herein as a single, substantially indivisible layer of material(s).

One or more functional elements are contained within or otherwise disposed within the monolithic structure of interlayer 125. Suitable functional elements include, but are not limited to, solar control elements, luminophores, ionomers, and optical elements, such as UV absorbers, UV reflectors, IR absorbers, IR reflectors and the like. In one embodiment, the functional elements comprise solar control elements. Suitable solar control elements include, but are not limited to, heat absorbers, heat reflectors, light filters, photovoltaic assemblies, electrochromic assemblies and a combination thereof.

Interlayer 125 comprises a TPU that is substantially optically clear and has sufficient adhesive properties to bond to various materials, such as glass, polycarbonate, acrylic and the like. In an exemplary embodiment, the TPU comprises an aliphatic TPU, preferably a polyether aliphatic TPU. The polyether aliphatic TPU may have a hardness in the range of about 60 Shore A to about 100 Shore A, or about 70 Shore A to about 85 Shore A.

Aliphatic TPUs are staple compounds with excellent optical clarity that generally do not break down (i.e., yellow) when exposed to UV light. In addition, polyether aliphatic TPU is incredibly sticky and will adhere to many different substances, such as polycarbonate, acrylic and the like. Thus, the monolithic interlayer described herein is analogous to a double-sided adhesive film or tape with solar control properties that enables the user to attach or laminate many different materials, including polycarbonate, glass and/or acrylic, to one or both sides of the tape.

Interlayer 125 preferably has a thickness suitable for adhering to outer layers 110, 120, or at least about 0.015 inches, preferably in the range of about 0.015 inches to about 0.100 inches. In an exemplary embodiment, the overall interlayer 125 has a thickness of about 0.015 inches to about 0.05 inches or about 0.015 inches to about 0.04 inches, or about 0.02 to about 0.025 inches.

In embodiments, the interlayer is substantially optically clear. Thus, the interlayer may have a haze of less than about 4%, or less than about 3%, or less than or equal to about 1.7%, or less than or equal to about 1%. The interlayer may have a visible light transmission percentage (VLT %) of greater than about 30%, or greater than about 50%, or greater than about 70%, or greater than about 80% or about 86% or greater. The interlayer may have an ultraviolet to visible spectrum transmission (UV-VIS) of about less than about 10% or less than about 5% or less than or equal to about 1%. The interlayer may have a yellowness index (E313) of less than about 6, or less than about 5, or less than about 4, or less than about 2.

In embodiments, the interlayer may comprise one or more optical elements that block or reflect certain wavelengths of light. In embodiments, the interlayer may substantially block or reflect certain wavelengths in the range of 100-400 nm. In one such embodiment, the interlayer may a light transmission at 380 nm of less than about 0.1 percent, or less than about 0.05 percent or less than or equal to about 0.04 percent. The interlayer may have a light transmission at 400 nm of less than about 50%, or less than about 10%, or less than about 2%, or less than about 1%, or less than about 0.02 percent.

In one embodiment, interlayer 125 comprises first and second TPU layers 130, 140 and a third internal TPU layer 150 with a coating 160 embedded within the first and second TPU layers 130, 140. The first and second layers 130, 140 preferably comprise aliphatic TPU, as described above. The functional elements are disposed on coating 160 such that the third TPU layer 150 provides a substrate for retaining the functional elements on coating 160.

In an exemplary embodiment, third TPU layer 150 comprises a polycaprolactone-based TPU. Polycaprolactone-based TPUs are harder than aliphatic TPUs and more suitable for applying coatings thereto. In an exemplary embodiment, the third TPU layer has a hardness of about 40 Shore D to about 85 Shore D, or about 55 Shore D to about 70 Shore D. Polycaprolactone-based TPUs, however, are generally not as optically transparent as aliphatic TPUs (i.e., they have a higher yellowness index). Thus, providing an aliphatic TPU as the primary interlayer with a thinner polycaprolactone-based TPU therein provides an interlayer with suitable adhesive and optical properties, while allowing functional elements or solar control functionality to be disposed therein. In addition, the aliphatic TPU is relatively lightweight (as compared to other TPUs, or other interlayer materials, such as PVB) making the laminate particularly suitable for applications requiring a lighter weight structure, such as electric cars, and the like.

In certain embodiments, the TPU is selected such that it is bendable or formable to create bent or curved laminates with solar control properties. In this embodiment, the laminate may be used with curved glass, polycarbonate or the like to manufacture, for example, bow windows, arch windows, bay windows, turret windows, precurved vehicle windows, curved bullet resistant windows and the like.

First layer 130 may be extruded onto a first surface of the internal TPU layer 150 and second layer 140 may be extruded onto a second surface of TPU layer 150 opposite the first surface (or directly onto coating 160). The first and second layers 130, 140 may be extruded separately or together as part of a single process. In either process, the first and second TPU layers 130, 140 and the internal TPU layer 150 melt together to form a single monolithic TPU interlayer that incorporates the internal solar control properties. In an exemplary embodiment, the first and second layers 130, 140 may each have a thickness of about 0.005 to about 0.025 inches, preferably about 0.005 to about 0.015 inches, or about 0.01 inches.

Internal TPU layer 150 has a thickness suitable for providing solar control properties thereon. In one embodiment, internal layer 150 has a thickness less than about 0.003 inches, or about 0.008 inches.

Coating 160 may be applied to TPU layer 150 in any manner suitable, such drop casting, dip coating, optical deposition, vacuum deposition, electrospinning, electro spraying, layer-by-layer deposition, spin coating and the like. In an exemplary embodiment, coating 160 is sputter coated onto layer 150. Internal TPU layer 150 may have a thickness of about 0.00075 to about 0.0009 inches, preferably about 0.0008 inches.

Outer layers 110, 120 comprise an optically transparent, substantially rigid material. Suitable materials for outer layers 110, 120 include, but are not limited to, glass, artificial glass, or any well-known glass substitute, such as polycarbonates, acrylic resins, polyesters, polyethers, and polyurethane. In one embodiment, outer layers 110, 120 comprise a float, tempered or chemically strengthened glass, such as borosilicate glass.

In another embodiment, outer layers 110, 120 comprise polycarbonate. In this embodiment, the laminate may have sufficient impact resistance to function as, for example, a bulletproof glass window.

In another embodiment, outer layers 110, 120 comprise acrylic. In this embodiment, the laminate may comprise a decorative film for applying to windows, doors, walls and the like.

Interlayer 125 may include optoelectrical properties suitable for the application of LGU 100. In embodiments, interlayer 125 may have quantum yield of greater than about 50%. Quantum yield (Φ) is defined as the ratio of the number of photons emitted to the number of photons absorbed.

Interlayer 125 may comprise an adhesion promoter to enhance the bonding between outer layers 110, 120 and the interlayer 125 and prevent delamination of the adhesive from the layers. Suitable adhesion promoters include, but are not limited to, organosilanes, organotitanates, zirconates, zircoaluminates, alkyl phosphate esters, metal organics and the like.

The composite laminate 100 is optically clear. In some embodiments, laminate allows a light transmission of at least about 30%, or at least about 50% or preferably at least about 70%. Laminate 100 may also have a haze of less than about 2%, or less than or equal to about 1% or preferably less than or equal to about 0.7%

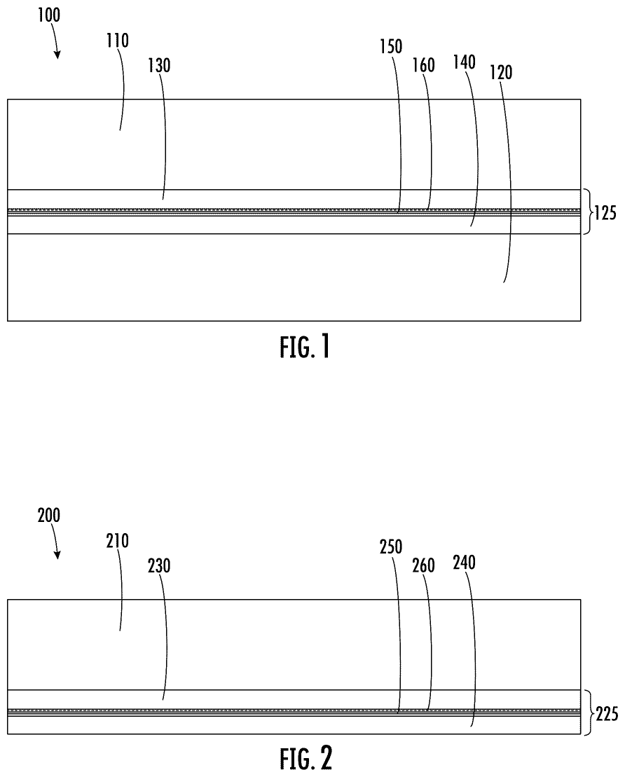

Referring now to FIG. 2, another embodiment of a laminate 200 comprises an optically transparent optical layer 210 and an adhesive interlayer 225 laminated to optical layer 210. Interlayer 125 is a monolithic structure comprising a thermoplastic polyurethane (TPU) that has a sufficient thickness to adhere to outer layers 110, 120, preferably at least about 0.015 inches. One or more functional elements are contained within or otherwise disposed within the monolithic structure of polymer interlayer 125.

Interlayer 225 comprises a TPU that is substantially optically clear and has sufficient adhesive properties to bond to various materials, such as glass, polycarbonate, acrylic and the like. In an exemplary embodiment, the TPU comprises an aliphatic TPU, preferably a polyether aliphatic TPU.

In one embodiment, interlayer 225 comprises first and second TPU layers 230, 240 and a third internal polymer layer 250 with a coating 260 disposed within the first and second TPU layers 230, 240. The functional elements are disposed on coating 260 such that the third TPU layer 250 provides a substrate for retaining the functional elements on coating 160. In an exemplary embodiment, third TPU layer 250 comprises a polycaprolactone-based TPU.

In certain embodiments, coatings 160 or 260 comprise one or more optical elements, materials and/or layers made from materials that allow the transmission of visible light and reflect or absorb UV and/or IR light. Alternatively, the optical elements, material and/or layers may be bonded to one or more of the TPU layers, such as TPU layers 230, 240 and/or 250 in FIG. 2 or TPU layers 130, 140 and/or 150 in FIG. 1. For example, an IR blocking optical element may be configured to reflect or absorb light having a wavelength of about 700 nanometers to 1 mm, preferably between about 700 nm to about 1400 nm (i.e., near-infrared wavelengths) and more preferably between about 750 nm to about 1200 nm. In one embodiment, the optical element comprises an IR-reflective coating. Suitable materials for reflecting light having wavelengths in the IR range include metal or metal-based coatings, such as double-layer or triple-layer silver coatings, liquid crystal materials that selectively operate to transmit or scatter IR light and the like.

In another embodiment, the optical element comprises an IR absorbing material, such as an IR absorbing dye, copper salt compositions, such as copper phosphonate, nanoparticles (such as zinc oxide, antimony tin oxide (ATO), lanthanum hexaboride (LaB) and the like), infrared filters, such as blue glass, interlayer films comprising infrared-shielding fine particles, and the like.

In yet another embodiment, the IR absorbing element includes IR absorbing particles, such as nanoparticles, dispersed into one of the TPU layers. In this embodiment, for example, the first TPU layer may include the UV blocking material, while the second TPU layers includes the IR blocking particles.

In certain embodiments, coatings 160 or 260 may include an optical element, layer or material that can either reflect or absorb UV light. The UV blocking optical element preferably reflects or absorbs light having a wavelength between about 10 and 400 nanometers, more preferably greater than about 380 nanometers and even more preferably between about 380 and 400 nanometers. Alternatively, the optical elements, material and/or layers may be bonded to one or more of the TPU layers, such as TPU layers 230, 240 and/or 250 in FIG. 2 or TPU layers 130, 140 and/or 150 in FIG. 1. The optical element may comprise any suitable material configured to reflect or absorb UV light, such as UV radiation absorbing, blocking or screening additives. UV radiation absorbing, blocking or screening additives suitable for the present disclosure include bezophenones, cinnamic acid derivatives, esters of benzoin acids, alicylic acid, terephthalic and isophthalic acids with resorcinol and phenols, pentamethyl piperidine derivatives, salicylates, benzotriazoles, cyanoacrylates, benzylidenes, malonates and oxalamides combined with nickel chelates and hindered amines.

Alternatively, the UV blocking optical element may comprise a light filtering layer within the TPU layer. Suitable optical elements for use herein include sheet polarizers, dichroic, reflective filter material to provide wide band UV radiation reduction and the like. For example, blue or green tinted glass with greatly reduced transmission in the UV portion or blue or green tinted polymeric interlayers, coatings or layers of UV radiation reducing paint or lacquer or polymeric films may be suitable as the UV blocking material.

In certain embodiments, the optical element comprises an IR blocker layer that can either reflect or absorb IR light and a separate UV blocker element that can either reflect or absorb UV light. The IR blocker element is preferably disposed between, and in contact with, the UV blocker element and one of the first and second thermoplastic polyurethane layers 130, 140. The IR blocker element can either reflect or absorb light having wavelengths between about 700 nanometers and about 1 mm, preferably between about 700 to about 1400 nanometers, more preferably between about 750 to about 1200 nanometers. The UV block element preferably can either reflect or absorb light having wavelengths between about 10 and 400 nanometers, preferably between about 380 and 400 nanometers.

Alternatively, the optical element may comprise a single material that blocks both UV and IR light. Suitable materials for the optical layer in this embodiment may comprise metal coatings, such as double or triple silver layers, and the like. A more complete description of optical elements for absorbing or reflecting IR and UV light can be found in commonly assigned International Application No. PCT/US2021/40300, titled Laminates with Optical Layers or Materials, filed Jul. 20, 2021, the complete description of which is incorporated herein by reference for all purposes.

In certain embodiments, coatings 160 or 260 comprise one or more luminophores. In an exemplary embodiment, the luminophores are fluorophores, which are fluorescent chemical compounds that are configured to re-emit light upon light excitation. Fluorophores typically comprise several combined aromatic groups, or planar or cyclic molecules with several 7L bonds. In one embodiment, the interlayers 150, 160 comprises a plurality of fluorophores finely dispersed into a polyurethane matrix.

The luminophores may be configured to absorb the majority of NIR or UV photons passing through interlayers 125, 225. In one embodiment, interlayers 125, 225 comprise phosphorescent organic molecules or blends of multiple luminophores (such as quantum dots or organic dyes) that act to reduce reabsorption losses and enhance overall absorption efficiencies across the spectrum. In one such embodiment, the luminophores have a structure selected from the group including, but not limited to, MX2 L2, AMX2L2, M6X12L2, A2M6X14, and A2M6X14.L2 where M=W or Mo, X—Cl, Br, or I, L=C1, CH3CN, a benzenethiol, ethanethiol, H2O (hydrate), HCl, and acetonitrile, and A=K, Na, tetrabutylammonium (TBA), and other ammonium salts. In another embodiment, the plurality of luminophores includes a quantum dot with core/shell structure selected from a group including, but not limited to: CdSe/CdS, CdSe/ZnSe, CdSe/ZnS, CdSe/ZnTe, CdSe/CdTe, CdTe/CdSe, CdTe/CdS, CdTe/ZnSe, CdTe/ZnS, CdTe/ZnTe, CdS/ZnSe, CdS/ZnS, CdS/CdTe, CdS/CdSe, PbSe/PbS, PbS/PbSe, PbTe/PbS, PbS/PbTe, PbTe/PbSe, PbSe/PbTe, PbSe/CdSe, CdSe/PbTe, PbS/CdS, CdS/PbS, PbTe/CdTe, CdTe/PbTe, InAs/CdS, InSb/CdS, InP/CdS, InAs/CdSe, InSb/CdSe, InP/CdSe, InAs/ZnSe, InP/ZnSe, InSb/ZnSe, InAs/ZnS, InP/ZnS, InSb/ZnS, Ge/Si, Si/Ge, Sn/Si, Si/Sn, Ge/Sn, or Sn/Ge.

In some embodiments, laminate 100 or 200 may comprise an ionomer or a polymer composed of repeat units of both electrically neutral repeating units and ionized units covalently bonded to the polymer backbone as pendant group moieties. A certain mole percent, e.g., 15% or less, is ionized. The ionomer may have unique physical properties, such as electrical conductivity and viscosity.

In certain embodiments, laminate 100 or 200 may include photovoltaic, electrochromic and/or other functionalities for conductive performance. In one such embodiment, laminate 100 comprises a photovoltaic assembly within coating 160. For example, quantum dots can be provided within coating 160. Another suitable alternative to quantum dots for energy generation is organic photovoltaic (OPV) cells, which may be employed here. Organic photovoltaic technology is rapidly emerging due to improving cell efficiency, positive performance lifetime, and demonstrated potential for roll-to-roll manufacturing using solution processing. OPV may be an attractive alternative since it offers absorbers in any color, and the ability to make efficient transparent devices. A diversity of organic materials can be used to design and synthesize the absorber, acceptor and interfaces, another benefit. Organic photovoltaic cells may be applied using thin-film deposition such as by sputtering and pulsed-laser deposition to create this thin-film OPV for energy generation. A more complete description of a suitable photovoltaic assembly can be found in commonly assigned co-pending U.S. Provisional Patent Application Ser. No. 63/470,128 (“Functional Glass and Artificial Glass Laminates”), filed May 31, 2023, the complete disclosure is incorporated herein by reference for all purposes.

In certain embodiments, laminates 100 or 200 may include an electrochromic assembly (“EC”). An electrochromic assembly includes an ion conducting interlayer film disposed between a first electrode layer and a second electrode layer. Wires can connect the photovoltaic assembly to the electrochromic assembly, in some embodiments, with the photovoltaic assembly providing power to the electrochromic assembly. In other examples, the electrical connection can be a busbar, conductive traces, or some other form of electrical connection. In certain embodiments, the electrochromic assembly is connected to an electric potential that is external to the window unit. Suitable electrochromic assemblies can be found in the above-referenced patent application (“Functional Glass and Artificial Glass Laminates”) and in commonly assigned co-pending International Patent Application Serial No. PCT/US2021/63210 (“Optically Transparent Electrolyte Films”), filed Dec. 14, 2021, the complete disclosure is incorporated herein by reference for all purposes.

It should be understood that the interlayers, functional laminates, and the insulated glass units (IGUs) described herein can be incorporated into a self-contained window unit, without requiring wiring connections outside of the unit, improving the energy efficiency of a building or vehicle. For example, the laminates may be used in an all-in-one dynamic glazing product that is suitable for use as windows in buildings, dwellings, housing structures, transportation and construction equipment such as trucks, tractors and buses, automobiles, aviation devices such as airplanes and helicopters, protective storage containers such as glass sealed cases, optical lenses in electronic equipment, etc. and other such applications where glass or glass laminates with performance layers may be utilized.

The window may incorporate an electrochromic assembly and/or a photovoltaic assembly to controls the transmittance of light, and provides a source of electrical power for electrochromic features of the unit. The unit is self-contained without needing wiring connections to power sources outside the unit. Automatic control of light transmittance and other features can be included, while the unit has the optical characteristics and aesthetics required for windows.

The interlayers and laminates described herein may be incorporated into an insulated glass unit (“IGU”). The all-in-one dynamic glazing product comprises an IGU that has an electrochromic assembly and a photovoltaic assembly separated by a gap and held together in a frame. The electrochromic assembly includes a first electrode layer a second electrode layer, and an ion conducting interlayer film disposed between the first electrode layer and the second electrode layer. The application of an electrical potential across the assembly results in a change in color and the light transmissivity of the assembly. The electrochromic assembly can vary the degree of light transmissivity to a desired extent. This can reduce the need for cooling in a building or vehicle, while allowing some light to enter. However, a source of electrical power is required to change the state of the electrochromic assembly.

The photovoltaic assembly may have a series of LSCs disposed in a polymeric interlayer that can be extruded and assembled into a laminate. For example, quantum dots can be provided in a thermoplastic polyurethane (“TPU”), ethylene co-vinyl acetate (“EVA”), or polymethyl methacrylate (“PMMA”). In some embodiments, the layer is extruded by a single or two screw extrusion, coated, cast, UV cured, or formed by other methods. Wires connect the photovoltaic assembly to the electrochromic assembly, so that the IGU is a self-contained unit, with the photovoltaic assembly providing power to the electrochromic assembly. In other embodiments, the power for the electrochromic assembly is provided by an external source. The IGU may include a transceiver for wireless communication with an external control unit or computer for controlling the electrochromic aspects of the IGU automatically. For example, the electrochromic features can be used to block transmissivity of light during different hours of the day, and according to regimens that vary seasonally or based on user preferences. The IGU can communicate with home control systems through the transceiver and be part of a system that controls heating, ventilation and cooling, such as smart thermostats and other known systems, such as Internet of Things (IoT) devices. Similar systems and devices can be incorporated in a vehicle as well.

In some embodiments, the LSCs are colloidal semiconductor nanocrystals, also called quantum dots, which are typically less than 20 nanometers in diameter. Natural light excites electrons of the quantum dot and the energy is directed to the sides of the layer. Photovoltaic cells convert the energy into electrical energy. For example, the photovoltaic cells are provided at the long sides of the layer, in intimate contact with it, or the photovoltaic cells are provided in areas adjacent to the transparent part of the window.

### Example 1

Applicant prepared and evaluated samples of the interlayers and laminates described above. The visible light transmission percentage (VLT %), haze %, and the percentage transmission of ultraviolet to visible spectrum transmission (UV-VIS) at about 365 nanometers were tested for each sample. The results of this testing are shown below in Table 1. Sample 1 was an internal TPU layer with a coating that incorporated solar control properties by itself (Sample 1). Sample 2 was a laminate that included the internal TPU layer disposed with an Argotec™ HP8000 aliphatic TPU interlayer extruded onto the film with 2 passes and first and second outer layers of glass. Sample 3 was a laminate that includes the internal TPU layer disposed with an Argotec™ ST-6050 aliphatic TPU interlayer extruded onto the film with 2 passes and first and second outer layers of glass.

TABLE 1

| | | Sample 1 | Sample 2 | Sample 3 |
|---|---|---|---|---|
| Haze-Gard | VLT (%) | 77 | 73 | 73 |
| | Haze (%) | 3.6 | 1 | 1.2 |
| UV-VIS | 365 nm % T | 35 | 0 | 0 |

As shown in Table 1, the laminates (Samples 2 and 3) had a VLT of about 73%, a Haze percentage of about 1 and 1.2 and a UV-VIS % at 365 nm of about 0.

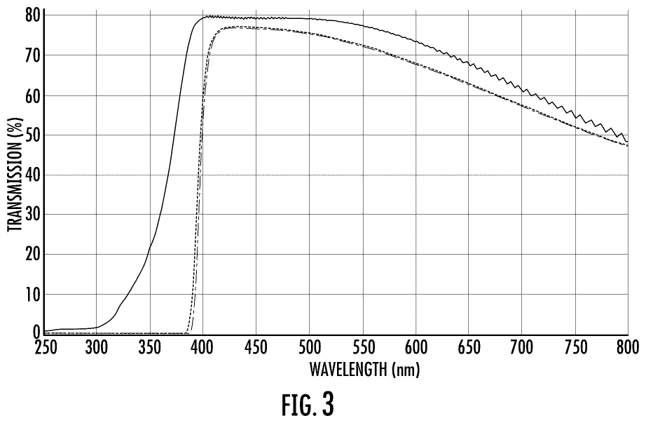

FIG. 3 illustrates a graph illustrating the transmission percentage of the samples at different wavelengths (in nanometers). As shown, the transmission of UV light (i.e., 100 to 380 nm) is minimal, while the transmission of visible light (i.e., 400 to 700 nm) extends up to 80% at lower wavelengths and higher frequencies, while it starts to taper at higher wavelengths in the visible range (down to about 55-60% at 700 nm at the beginning of the IR range).

### Example 2

The visible light transmission percentage (VLT %), haze %, Yellowness Index (YI), CIELAB color space coordinates (L, a* and b*) and the percentage transmission of ultraviolet to visible spectrum transmission (UV-VIS) at about 380 nanometers and 400 nanometers were evaluated for each sample. Samples 4A and 4B comprised two 635 micrometer Argotec™ HP8000 aliphatic TPU layers extruded without an internal TPU layer with a coating that incorporated solar control properties. Samples 5A and 5B comprised an internal TPU layer with a coating that incorporated solar control properties further encapsulated by extruding two 635 micrometer Argotec™ HP8000 aliphatic TPU layers on either side. Samples 6A and 6B comprised an internal TPU layer with a coating that incorporated solar control properties further encapsulated by extruding a 635 micrometer Argotec™ HP8000 aliphatic TPU layer on one side, and another 635 micrometer Argotec™ HP8000 aliphatic TPU layer containing enhanced UV blocker on the other side. Finally, Samples 7A and 7B comprised an internal TPU layer with a coating that incorporated solar control properties further encapsulated by extruding two 635 micrometer Argotec™ HP8000 aliphatic TPU layers containing enhanced UV blocker on both sides. Each interlayer was laminated between two panes of clear borosilicate glass via standard vacuum bag autoclave lamination process.

The results of the evaluation of Samples 4A-7B are shown in TABLE 2 below. As shown, samples 4-7 all had minimal light transmission at 380 nm and Samples 6 and 7 had minimal light transmission even at 400 nm due to the enhanced UV blocking properties. All samples had light transmission in excess of 85% and haze well below 3% as required by optical applications. The samples that included an internal third TPU layer between the first and second aliphatic TPU layers and a coating that incorporated solar control properties caused only a marginal increase in haze and YI as seen from Sample 5 vis-à-vis Sample 4. Incorporation of enhanced UV blocking capabilities caused the YI to increase but had no effect on haze or light transmission as seen from Samples 6 and 7 vis-à-vis Sample 5.

TABLE 2

| Sample | 4A | 4B | 5A | 5B | 6A | 6B | 7A | 7B |
|---|---|---|---|---|---|---|---|---|
| VLT (%) | 94 | 94 | 86 | 86 | 86 | 86 | 86 | 86 |
| % Haze | 0.8 | 1.1 | 1.4 | 1.7 | 1.0 | 1.3 | 1.2 | 1.0 |
| YI (E313) | 1.1 | 1.1 | 1.7 | 1.7 | 3.3 | 3.7 | 4.9 | 5.1 |
| L | 97.07 | 97.12 | 93.88 | 93.65 | 94.05 | 93.85 | 93.68 | 93.74 |
| a* | −0.28 | −0.32 | −0.97 | −0.94 | −1.54 | −1.62 | −2.02 | −2.1 |
| b* | .078 | 0.76 | 1.4 | 1.1 | 2.2 | 2.44 | 3.2 | 3.34 |
| 360 mm % T | 0.02 | 0.01 | −0.02 | 0.04 | −0.04 | −0.02 | −0.03 | −0.03 |
| 400 nm % T | 54.50 | 52.29 | 44.66 | 44.00 | 1.12 | 1.16 | 0.09 | 0.11 |

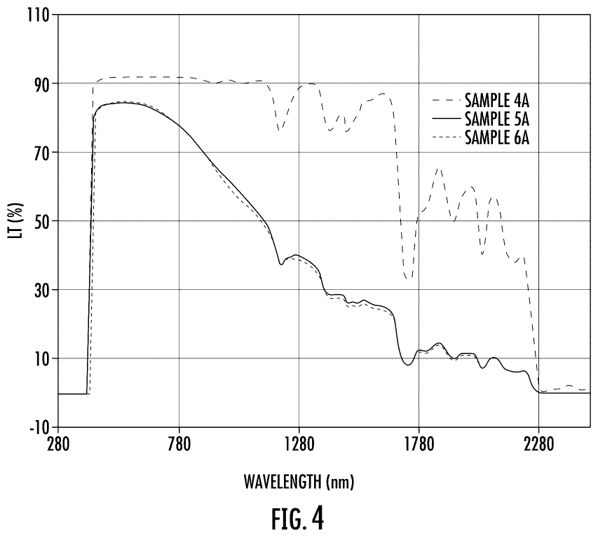

FIG. 4 illustrates the light transmission spectra for Samples 4A, 5A and 6A. Sample 5A and 6A have lower light transmission than that of Sample 4A at all wavelengths tested. However, the drop in light transmission is much more pronounced in the near infrared region that spans 800-2,500 nm. This drop is because of the solar control coating on the core TPU layer. Sample 4A does not contain this solar control coating, and as a result, does a poor job of blocking near infrared light that is primarily responsible for heat gain.

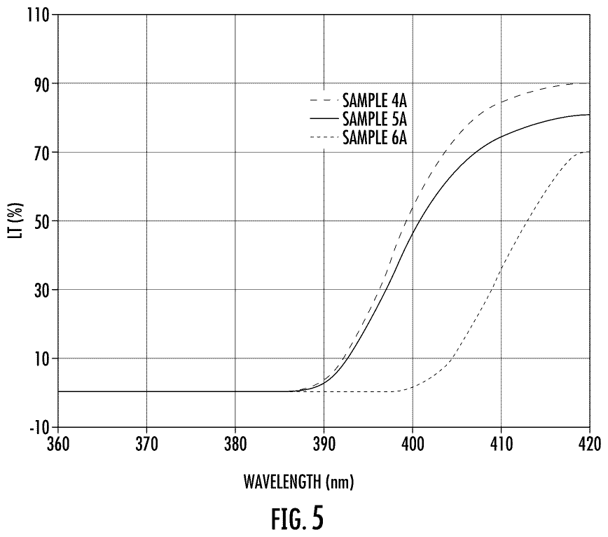

FIG. 5 illustrates the UV region of the spectrum (280-400 nm) to demonstrate the contribution of the enhanced UV blocker. While Samples 4A and 5A show an increase in light transmission beyond 390 nm, Sample 6A blocks UV light up to 400 nm. As seen from FIG. 7, Sample 6A combines enhanced UV blocking without jeopardizing infrared shielding properties imparted by the core TPU layer containing a coating with solar control properties. Results depicted in FIGS. 7 and 8 were obtained on Cary 5000 UV-Vis-NIR spectrophotometer.

While the materials and products formed from these materials have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in one aspect, a first embodiment is an interlayer comprising an adhesive film, the film having a monolithic structure comprising a thermoplastic polyurethane (TPU), the film further comprising one or more functional elements within its monolithic structure. The film has a thickness of at least about 0.015 inches.

A second embodiment is the first embodiment, wherein the film has a thickness of about 0.015 inches to about 0.100 inches.

A third embodiment is any combination of the first 2 embodiments, wherein the TPU comprises an aliphatic TPU.

A 4^{th} embodiment is any combination of the first 3 embodiments, wherein the aliphatic TPU comprises a polyether aliphatic TPU.

A 5^{th} embodiment is any combination of the first 4 embodiments, wherein the polyether aliphatic TPU has a hardness of about 70 Shore A to about 85 Shore A.

A 6^{th} embodiment is any combination of the first 5 embodiments, wherein the monolithic structure comprises a first upper TPU layer and a second lower TPU layer.

A 7^{th} embodiment is any combination of the first 6 embodiments, wherein the first and second layers each have a thickness of about 0.005 inches.

An 8^{th} embodiment is any combination of the first 7 embodiments, wherein the monolithic structure further comprises a third TPU layer disposed between the first and second layers.

A 9^{th} embodiment is any combination of the first 8 embodiments, wherein the third TPU layer comprises an aliphatic TPU.

A 10^{th} embodiment is any combination of the first 9 embodiments, wherein the aliphatic TPU layer is a polycaprolactone-based TPU.

An 11^{th} embodiment is any combination of the first 10 embodiments, wherein the polycaprolactone-based TPU has a hardness of about 55 Shore D to about 70 Shore D.

A 12^{th} embodiment is any combination of the first 11 embodiments, wherein the functional elements comprise one or more of luminophores, solar control elements, ionomers, UV absorbers, UV reflectors, IR absorbers, IR reflectors and a combination thereof.

A 13^{th} embodiment is any combination of the first 12 embodiments, wherein the solar control elements comprise one or more of heat absorbers, heat reflectors, light filters, photovoltaic assemblies, electrochromic assemblies and a combination thereof.

A 14^{th} embodiment is any combination of the first 13 embodiments, wherein the luminophores comprise phosphorescent organic molecules, quantum dots, organic dyes or combinations thereof.

A 15^{th} embodiment is any combination of the first 14 embodiments, wherein the one or more functional elements are disposed on a coating and the coating is adhered to the third TPU layer.

A 16^{th} embodiment is any combination of the first 15 embodiments, wherein the film is sputter coated onto the internal polymer layer.

A 17^{th} embodiment is any combination of the first 16 embodiments, wherein the coating and the third TPU layer have a thickness of less than about 0.003 inches.

An 18^{th} embodiment is any combination of the first 17 embodiments, wherein the TPU layer is substantially optically clear.

A 19^{th} embodiment is any combination of the first 18 embodiments, wherein the interlayer has a visible light transmission percentage of at least about 85.

A 20^{th} embodiment is any combination of the first 19 embodiments, wherein the interlayer has a percentage haze of less than about 1.7 percent.

A 21^{st} embodiment is any combination of the first 20 embodiments, wherein the interlayer has a yellowness index (YI) of less than about 5.0.

A 22^{nd} embodiment is any combination of the first 21 embodiments, wherein the interlayer has a light transmission at 380 nm of less than about 0.04 percent.

A 23^{rd} embodiment is any combination of the first 22 embodiments, further comprising an optical material on the TPU configured to reflect or absorb UV light.

A 24^{th} embodiment is any combination of the first 23 embodiments, wherein the interlayer has a light transmission at 400 nm of less than about 40 percent.

A 25^{th} embodiment is any combination of the first 124 embodiments, wherein the light transmission at 400 nm is less than about 10 percent.

A 26^{th} embodiment is any combination of the first 25 embodiments, wherein the light transmission at 400 nm is less than about 2 percent.

A 27^{th} embodiment is any combination of the first 26 embodiments, wherein the one or more outer layers comprises a material selected from the group consisting of glass, artificial glass, polycarbonates, acrylics, polyesters, polyethers, and polyurethanes.

In another aspect, a laminate is provided comprising any combination of the first 26 embodiments.

In another aspect, a window is provided comprising any combination of the first 26 embodiments.

In another aspect, a decorative film is provided comprising any combination of the first 26 embodiments.

In another aspect, a laminate comprises a first optically transparent layer and a second layer adhered to the first layer, the film having a monolithic structure comprising a thermoplastic polyurethane (TPU), the second layer further comprising one or more functional elements within its monolithic structure, wherein the second layer has a thickness of at least about 0.015 inches.

A second embodiment is the first embodiment further comprising a third optically transparent layer, wherein the second layer is adhered to the third layer.

A third embodiment is any combination of the first 2 embodiments, wherein the second layer is disposed between the first and third layers.

A 4^{th} embodiment is any combination of the first 3 embodiments, wherein the first layer comprises a material selected from the group consisting of glass, artificial glass, polycarbonates, acrylics, polyesters, polyethers, and polyurethanes.

A 5^{th} embodiment is any combination of the first 4 embodiments, wherein the first layer comprises a material selected from the group consisting of glass, polycarbonate and acrylic.

A 6^{th} embodiment is any combination of the first 5 embodiments, wherein the TPU comprises an aliphatic TPU.

A 7^{th} embodiment is any combination of the first 6 embodiments, wherein the aliphatic TPU comprises a polyether aliphatic TPU.

An 8^{th} embodiment is any combination of the first 7 embodiments, wherein the monolithic structure comprises a first upper TPU layer and a second lower TPU layer.

A 9^{th} embodiment is any combination of the first 8 embodiments, wherein the first and second layers each have a thickness of about 0.005.

A 10^{th} embodiment is any combination of the first 9 embodiments, wherein the monolithic structure further comprises a third TPU layer disposed between the first and second layers, wherein the third TPU layer comprises polycaprolactone.

An 11^{th} embodiment is any combination of the first 10 embodiments, wherein the functional elements comprise one or more of luminophores, solar control elements, UV absorbers, UV reflectors, IR absorbers, IR reflectors and a combination thereof.

A 12^{th} embodiment is any combination of the first 11 embodiments, wherein the solar control elements comprise one or more of heat absorbers, heat reflectors, light filters, photovoltaic assemblies, electrochromic assemblies and a combination thereof.

A 13^{th} embodiment is any combination of the first 12 embodiments, wherein the luminophores comprise phosphorescent organic molecules, quantum dots, organic dyes or combinations thereof.

A 14^{th} embodiment is any combination of the first 13 embodiments, wherein the one or more functional elements are disposed on a coating, wherein the coating is adhered to the third TPU layer.

A 15^{th} embodiment is any combination of the first 14 embodiments, wherein the coating is sputter coated onto the third TPU layer.

A 16^{th} embodiment is any combination of the first 15 embodiments, wherein the coating and the third TPU layer have a thickness of less than about 0.003 inches.

An 17^{th} embodiment is any combination of the first 16 embodiments, wherein the first layer comprises glass and the functional elements comprise solar control elements selected from a group consisting of heat absorbers, heat reflectors, light filters, photovoltaic assemblies, electrochromic assemblies and a combination thereof.

An 18^{th} embodiment is any combination of the first 17 embodiments, wherein the first layer comprises polycarbonate and the functional elements comprise solar control elements selected from a group consisting of heat absorbers, heat reflectors, light filters, photovoltaic assemblies, electrochromic assemblies and a combination thereof.

A 19^{th} embodiment is any combination of the first 18 embodiments, wherein the laminate is bulletproof.

A 20^{th} embodiment is any combination of the first 19 embodiments, wherein the first layer comprises acrylic and the functional elements comprise solar control elements selected from a group consisting of heat absorbers, heat reflectors, light filters, photovoltaic assemblies, electrochromic assemblies and a combination thereof.

A 21^{st} embodiment is any combination of the first 20 embodiments, wherein the first layer and the adhesive film are non-linear.

In another aspect, a window is provided comprising any of the first 21 embodiments.

In another aspect, a solar control window is provided comprising any of the first 21 embodiments, wherein the first layer comprises glass.

In another aspect a panoramic roof for an automobile is provided comprising any of the first 21 embodiments.

In another aspect, an impact resistant window is provided comprising any of the first 21 embodiments, wherein the first layer comprises polycarbonate.

In another aspect, a decorative layer is provided comprising any of the first 21 embodiments, wherein the first layer comprises acrylic.

In another aspect, a first embodiment is an interlayer comprising a first thermoplastic polyurethane (TPU) layer, a second TPU layer and a third polymer layer disposed between the first and second polymer layers and comprising one or more functional elements.

A second embodiment is the first embodiment, wherein the third polymer layer comprises TPU.

A third embodiment is any combination of the first two embodiments, further comprising a coating on the third polymer layer, wherein the one or more functional elements are disposed on the coating.

A 4^{th} embodiment is any combination of the first 3 embodiments, wherein the coating is sputter coated to the third TPU layer.

A 5^{th} embodiment is any combination of the first 4 embodiments, wherein the coating and the third TPU layer have a thickness of less than about 0.003 inches.

A 6^{th} embodiment is any combination of the first 5 embodiments, further comprising an optical material on the first TPU layer, wherein the optical material is configured to reflect or absorb UV light.

A 7^{th} embodiment is any combination of the first 6 embodiments, further comprising a second optical material on the second TPU layer, wherein the second optical material is configured to reflect or absorb UV light.

An 8^{th} embodiment is any combination of the first 7 embodiments, wherein the first, second and third layers form a monolithic structure having a thickness of at least about 0.015 inches.

A 9^{th} embodiment is any combination of the first 8 embodiments, wherein the structure has a thickness of about 0.015 inches to about 0.100 inches.

A 10^{th} embodiment is any combination of the first 9 embodiments, wherein the first and second TPU layers each have a thickness of at least about 0.005 inches.

An 11^{th} embodiment is any combination of the first 10 embodiments, wherein the functional elements are selected from a group consisting of luminophores, solar control elements, ionomers, UV absorbers, UV reflectors, IR absorbers, IR reflectors and a combination thereof.

A 12^{th} embodiment is any combination of the first 11 embodiments, wherein the interlayer has a visible light transmission percentage of at least about 85.

A 13^{th} embodiment is any combination of the first 12 embodiments, wherein the interlayer has a percentage haze of less than about 1.7 percent.

A 14^{th} embodiment is any combination of the first 13 embodiments, wherein the interlayer has a yellowness index (YI) of less than about 5.0.

A 15^{th} embodiment is any combination of the first 14 embodiments, wherein the interlayer has a light transmission at 380 nm of less than about 0.04 percent.

A 16^{th} embodiment is any combination of the first 15 embodiments, wherein the interlayer has a light transmission at 400 nm of less than about 40 percent.

A 17^{th} embodiment is any combination of the first 16 embodiments, wherein the light transmission at 400 nm is less than about 10 percent.

An 18^{th} embodiment is any combination of the first 17 embodiments, wherein the light transmission at 400 nm is less than about 2 percent.

What is claimed is:

1. An interlayer comprising:
an adhesive film, the film having a monolithic structure comprising a thermoplastic polyurethane (TPU), the film further comprising one or more functional elements within its monolithic structure;
wherein the film has a thickness of at least about 0.015 inches.

2. The interlayer of claim 1, wherein the film has a thickness of about 0.015 inches to about 0.100 inches.

3. The interlayer of claim 1, wherein the monolithic structure comprises a first upper TPU layer and a second lower TPU layer.

4. The interlayer of claim 3, wherein the first and second layers each have a thickness of at least about 0.005 inches.

5. The interlayer of claim 3, wherein the monolithic structure further comprises a third TPU layer disposed between the first and second TPU layers.

6. The interlayer of claim 1, wherein the functional elements are selected from a group consisting of luminophores, solar control elements, ionomers, UV absorbers, UV reflectors, IR absorbers, IR reflectors and a combination thereof.

7. The interlayer of claim 6, wherein the one or more functional elements are disposed on a coating, wherein the coating is adhered to the third TPU layer.

8. The interlayer of claim 7, wherein the coating is sputter coated to the third TPU layer.

9. The interlayer of claim 8, wherein the coating and the third TPU layer have a thickness of less than about 0.003 inches.

10. The interlayer of claim 1, wherein the interlayer has a visible light transmission percentage of at least about 85.

11. The interlayer of claim 1, wherein the interlayer has a percentage haze of less than about 1.7 percent.

12. The interlayer of claim 1, wherein the interlayer has a yellowness index (YI) of less than about 5.0.

13. The interlayer of claim 1, wherein the interlayer has a light transmission at 380 nm of less than about 0.04 percent.

14. The interlayer of claim 1, further comprising an optical material on the TPU configured to reflect or absorb UV light.

15. The interlayer of claim 23, wherein the interlayer has a light transmission at 400 nm of less than about 2 percent.

16. A laminate comprising the interlayer of claim 1.

17. A window comprising the laminate of claim 16.

18. An interlayer comprising:
a first thermoplastic polyurethane (TPU) layer;
a second TPU layer; and
a third polymer layer disposed between the first and second polymer layers and comprising one or more functional elements.

19. The interlayer of claim 18, wherein the third polymer layer comprises TPU.

20. The interlayer of claim 19, further comprising a coating on the third polymer layer, wherein the one or more functional elements are disposed on the coating.

21. The laminate of claim 20, wherein the coating and the third TPU layer have a thickness of less than about 0.003 inches.

22. The laminate of claim 19, further comprising an optical material on the first TPU layer, wherein the optical material is configured to reflect or absorb UV light.

23. The interlayer of claim 22, further comprising a second optical material on the second TPU layer, wherein the second optical material is configured to reflect or absorb UV light.

24. The interlayer of claim 19, wherein the first, second and third layers form a monolithic structure having a thickness of at least about 0.015 inches.

25. The interlayer of claim 19, wherein the first and second TPU layers each have a thickness of at least about 0.005 inches.
